(19) United States
(12) Patent Application Publication
(10) Pub. No.: US 2025/0096897 A1
(43) Pub. Date: Mar. 20, 2025

(54) DEVICE SWITCHING METHOD AND OPTICAL COMMUNICATION SYSTEM

(71) Applicant: Nippon Telegraph and Telephone Corporation, Tokyo (JP)

(72) Inventors: Kenta ITO, Musashino-shi, Tokyo (JP); Hirokazu KAGEYAMA, Musashino-shi, Tokyo (JP); Satoshi SHIMAZU, Musashino-shi, Tokyo (JP); Takayoshi TASHIRO, Musashino-shi, Tokyo (JP); Tomoaki YOSHIDA, Musashino-shi, Tokyo (JP)

(21) Appl. No.: 18/728,923

(22) PCT Filed: Jan. 24, 2022
(86) PCT No.: PCT/JP2022/002392

§ 371 Date: Jul. 15, 2024

(51) Int. Cl. H04B 10/272; H04B 10/032; H04L 12/44; H04L 41/084

(52) U.S. Cl. CPC H04B 10/272; H04B 10/032; H04L 12/44; H04L 41/084

(57) ABSTRACT

There is provided a device switching method in an optical communication system including an upper-layer device, a switching source optical subscriber line terminal station device that is a device switching source, a switching destination optical subscriber line terminal station device that is a device switching destination, and an optical branching unit to which the switching source optical subscriber line terminal station device and the switching destination optical subscriber line terminal station device are connected. The optical branching unit has a branching ratio of M:N and has M first ports and N second ports. The switching source optical subscriber line terminal station device is connected to one first port, and the switching destination optical subscriber line terminal station device is connected to any of the remaining first ports of the M first ports. The device switching method starts communication by the switching destination optical subscriber line terminal station device after setting.

### TECHNICAL FIELD

The present invention relates to a device switching method and an optical communication system.

### BACKGROUND ART

In switching associated with renewal of an optical line terminal (OLT) in the related art, a switching destination OLT is installed in advance at a site, and a connectable cable is wired to the switching destination OLT. After preliminary preparation is completed, a local operator removes cables connected to the switching source OLT one by one, and reconnects the cables to the switching destination OLT. Alternatively, in a case where a passive optical network (PON) is assumed as an optical communication system as described in Patent Literature 1, an OLT and a plurality of optical network units (ONUs) are connected via a first splitter and a second splitter, and a switching device is connected between the first splitter and the second splitter. One branching of the first splitter is opened for switching. When a controller finds a failure of the OLT, the switching device is controlled such that the ONU connected to the OLT is connected to another normal OLT.

### CITATION LIST

### Patent Literature

Patent Literature 1: JP 2011-71951 A

### SUMMARY OF INVENTION

### Technical Problem

In the former method of switching the connection line to the ONU from the switching source OLT to the switching destination OLT, an optical fiber is inserted and removed for each user. As a result, communication is disconnected while the optical fiber is inserted and removed. Further, in the latter switching method by the switching device, switching is controlled by a controller, but communication disconnection occurs at the time of switching. As described above, in the related art, there is a problem that communication disconnection occurs at the time of switching.

In view of the above circumstances, an object of the present invention is to provide a technique capable of switching an optical subscriber line terminal station device by suppressing occurrence of communication disconnection at the time of switching an optical subscriber line terminal station device.

### Solution to Problem

According to an aspect of the present invention, there is provided a device switching method in an optical communication system including an upper-layer device, a switching source optical subscriber line terminal station device that is a device switching source, a switching destination optical subscriber line terminal station device that is a device switching destination, and an optical branching unit to which the switching source optical subscriber line terminal station device and the switching destination optical subscriber line terminal station device are connected, in which the optical branching unit has a branching ratio of M:N (M and N are integers equal to or larger than 2) and has M first ports and N second ports, the switching source optical subscriber line terminal station device is connected to one first port of the M first ports of the optical branching unit, and connecting the switching destination optical subscriber line terminal station device is connected to any one of the remaining first ports of the M first ports of the optical branching unit, and the device switching method starts communication by the switching destination optical subscriber line terminal station device after setting, for the switching destination optical subscriber line terminal station device, setting information which is set for the switching source optical subscriber line terminal station device.

According to another aspect of the present invention, there is provided an optical communication system including: an upper-layer device; a switching source optical subscriber line terminal station device that is a device switching source; a switching destination optical subscriber line terminal station device that is a device switching destination; and an optical branching unit to which the switching source optical subscriber line terminal station device and the switching destination optical subscriber line terminal station device are connected, in which the optical branching unit has a branching ratio of M:N (M and N are integers equal to or larger than 2) and has M first ports and N second ports, the switching source optical subscriber line terminal station device is connected to one first port of the M first ports, the switching destination optical subscriber line terminal station device is connected to any one of the remaining first ports of the M first ports, and the upper-layer device starts communication by the switching destination optical subscriber line terminal station device after setting, for the switching destination optical subscriber line terminal station device, setting information which is set for the switching source optical subscriber line terminal station device.

### Advantageous Effects of Invention

According to the present invention, it is possible to switch an optical subscriber line terminal station device by suppressing occurrence of communication disconnection at the time of switching an optical subscriber line terminal station device.

### BRIEF DESCRIPTION OF DRAWINGS

FIG. 1 is a diagram illustrating a configuration example of an optical communication system in the present invention.

FIG. 2 is a diagram illustrating a configuration of a splitter in an embodiment.

FIG. 3 is a diagram illustrating a configuration example of a control device in the embodiment.

FIG. 4 is a diagram illustrating a configuration example of an OLT in the embodiment.

FIG. 5 is a sequence diagram illustrating a flow of processing performed by the optical communication system in the embodiment.

### DESCRIPTION OF EMBODIMENTS

Hereinafter, an embodiment of the present invention will be described with reference to the drawings.

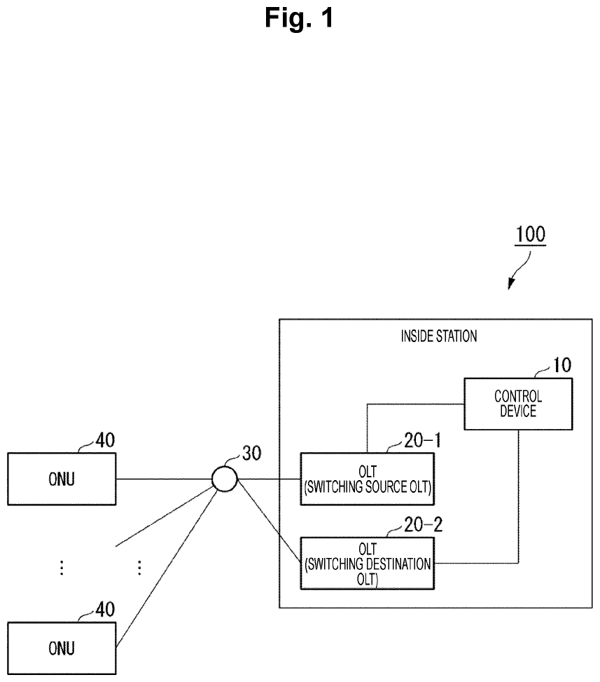

FIG. 1 is a diagram illustrating a configuration example of an optical communication system 100 in the present invention. The optical communication system 100 includes a control device 10, a plurality of OLTs 20-1 and 20-2, a splitter 30, and one or more ONUs 40. An optical fiber is connected between the OLT 20 and the splitter 30 and between the splitter 30 and the ONU 40.

The number of the OLTs 20, the splitters 30, and the ONUs 40 included in the optical communication system 100 is not particularly limited. For simplification of description, only one splitter 30 is illustrated in FIG. 1. On the other hand, a plurality of splitters 30 may be connected between the OLTs 20 and the ONUs 40.

The OLT 20-1 is an optical subscriber line terminal station device that is replaced due to aged deterioration or to provide new functions. The OLT 20-1 starts light emission and stops light emission for performing communication with the ONU 40 under a control of the control device 10. In the following description, the OLT 20-1 is also referred to as a switching source OLT 20-1 (switching source optical subscriber line terminal station device).

The OLT 20-2 is an optical subscriber line terminal station device serving as a switching destination from the switching source OLT 20-1. The OLT 20-2 starts light emission and stops light emission for performing communication with the ONU 40 under a control of the control device 10. In the following description, the OLT 20-2 is also referred to as a switching destination OLT 20-2 (switching destination optical subscriber line terminal station device).

The splitter 30 is an optical branching unit having a branching ratio of M:N (M and N are integers equal to or larger than 2). In the present embodiment, as an example, the splitter 30 will be described as a 4-branching splitter having a branching ratio of 4:4. The splitter 30 may be an 8-branching splitter having a branching ratio of 8:8. The splitter 30 has M (for example, 4) ports and N (for example, 4) ports. The switching source OLT 20-1 is connected to one port of the M ports of the splitter 30 via an optical fiber, and the switching destination OLT 20-2 is connected to any remaining port of the M ports of the splitter 30 via an optical fiber. The ONU 40 is connected to each of the N ports of the splitter 30 via an optical fiber. For example, the splitter 30 branches an optical signal which is input to any one port of the M ports into N paths, and outputs the branched optical signal from the N ports.

The ONU 40 is installed, for example, in a home of a subscriber who receives provision of a communication service. The ONU 40 performs communication with the OLT 20 via the splitter 30.

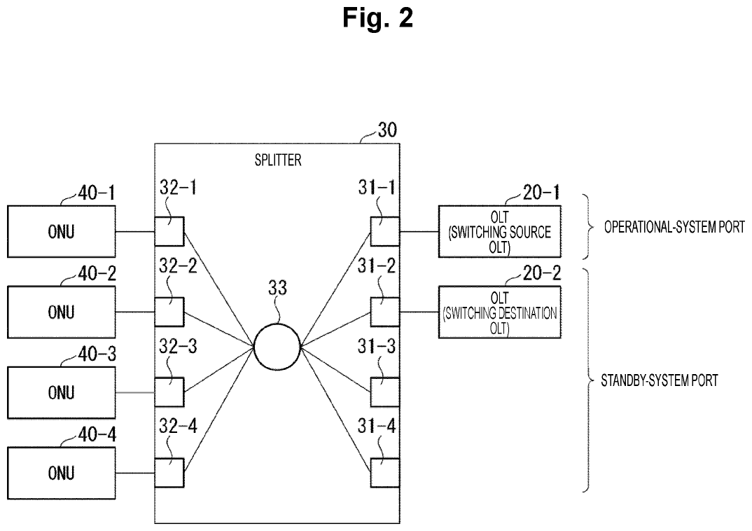

FIG. 2 is a diagram illustrating a configuration of the splitter 30 in the embodiment.

As illustrated in FIG. 2, the splitter 30 in the embodiment is configured with four ports 31-1 to 31-4, four ports 32-1 to 32-4, and a branching unit 33. One port 31 of the ports 31 of the splitter 30 is used as an operational-system port, and the remaining ports 31 are standby-system ports. Therefore, in the present invention, the switching destination OLT 20-2 is connected in advance to any of the ports 31-2 to 31-4, which are standby-system ports. The example illustrated in FIG. 2 illustrates an example in which the switching destination OLT 20-2 is connected to the port 31-2 which is a standby-system port.

The ONUs 40-1 to 40-4 are respectively connected to the ports 32-1 to 32-4. The branching unit 33 branches an optical signal which is input from any one port to other ports, and outputs the optical signal. For example, the branching unit 33 branches the optical signal which is input from the port 31-1 to the ports 31-1 to 31-4, and outputs the optical signal.

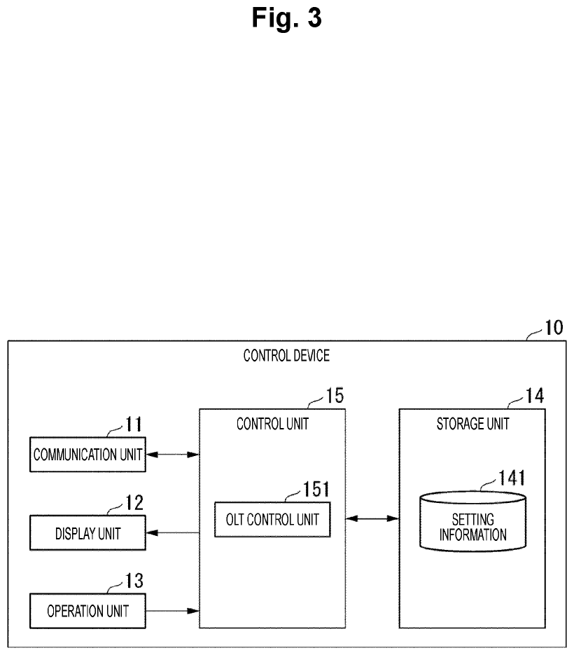

FIG. 3 is a diagram illustrating a configuration example of the control device 10 in the embodiment. The control device 10 includes a communication unit 11, a display unit 12, an operation unit 13, a storage unit 14, and a control unit 15.

The communication unit 11 performs communication with the switching source OLT 20-1 and the switching destination OLT 20-2. For example, the communication unit 11 transmits, to the switching destination OLT 20-2, setting information including information which is set for the switching source OLT 20-1 and information related to the ONU 40. For example, the communication unit 11 receives information related to the ONU 40 with which the switching source OLT 20-1 is performing communication. The information related to the ONU 40 is, for example, information of a wavelength used by the ONU 40.

The display unit 12 is an image display device such as a liquid crystal display or an organic electro luminescence (EL) display. The display unit 12 displays information. The display unit 12 may be an interface for connecting an image display device to the control device 10. In this case, the display unit 12 generates a video signal for displaying the control device 10, and outputs the video signal to the image display device connected to the display unit itself.

The operation unit 13 is configured by using an existing input device such as a keyboard, a pointing device (a mouse, a tablet, or the like), a touch panel, or a button. The operation unit 13 is operated by a user when inputting a user's instruction to the control device 10. For example, an instruction to start light emission or stop light emission in the OLT 20 is input to the operation unit 13. The operation unit 13 may be an interface for connecting an input device to the control device 10. In this case, the operation unit 13 inputs an input signal generated in response to a user's input in the input device to the control device 10.

The storage unit 14 stores setting information 141. The setting information 141 may include information which is set for the OLT 20 and information related to the ONU 40 connected to the OLT 20. The storage unit 14 is configured using a storage device such as a magnetic storage device or a semiconductor storage device.

The control unit 15 controls the entire control device 10. The control unit 15 is configured with a processor such as a central processing unit (CPU) and a memory. The control unit 15 realizes functions of an OLT control unit 151 by executing a program.

Some or all of the OLT control unit 151 may be implemented by hardware (circuits including a circuitry) such as an application specific integrated circuit (ASIC), a programmable logic device (PLD), or a field programmable gate array (FPGA) or by cooperation of software and hardware. The program may be recorded on a computer-readable recording medium. The computer-readable recording medium is, for example, a non-transitory storage medium including a portable medium such as a flexible disk, a magneto-optical disc, a ROM, or a CD-ROM and a storage device such as a hard disk built in a computer system. The program may be transmitted via an electrical communication line.

Some of functions of the OLT control unit 151 need not be provided in the control device 10 in advance, and may be implemented by installing an additional application program in the control device 10.

The OLT control unit 151 controls an operation of the OLT 20. For example, the OLT control unit 151 causes the switching source OLT 20-1 to stop light emission and causes the switching destination OLT 20-2 to start light emission in response to a user's instruction. Further, for the switching destination OLT 20-2, the OLT control unit 151 sets, as the setting information 141, setting information including information related to the switching source OLT 20-1 and information related to the ONU 40 with which the switching source OLT 20-1 is performing communication for the switching destination OLT 20-2.

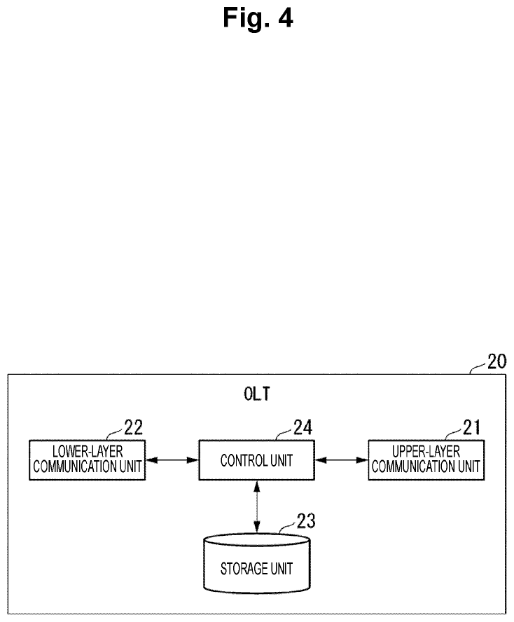

FIG. 4 is a diagram illustrating a configuration example of the OLT 20 in the embodiment. Since the switching source OLT 20-1 and the switching destination OLT 20-2 have the same configuration, a functional configuration of the OLT 20 will be described. The OLT 20 includes an upper-layer communication unit 21, a lower-layer communication unit 22, a storage unit 23, and a control unit 24.

The upper-layer communication unit 21 performs communication with the control device 10. The upper-layer communication unit 21 receives, for example, an instruction transmitted from the control device 10.

The lower-layer communication unit 22 performs communication with the ONU 40 via the splitter 30. For example, the lower-layer communication unit 22 generates an optical signal having a wavelength used by the ONU 40 as a communication target, and transmits the generated optical signal.

The storage unit 23 stores the setting information. For example, in a case where the setting information is transmitted from the control device 10, the setting information transmitted from the control device 10 is stored in the storage unit 23. The storage unit 23 is configured using a storage device such as a magnetic storage device or a semiconductor storage device.

The control unit 24 controls the entire OLT 20. The control unit 24 is configured with a processor such as a CPU and a memory. The control unit 24 controls, for example, start or stop of light emission in the lower-layer communication unit 22.

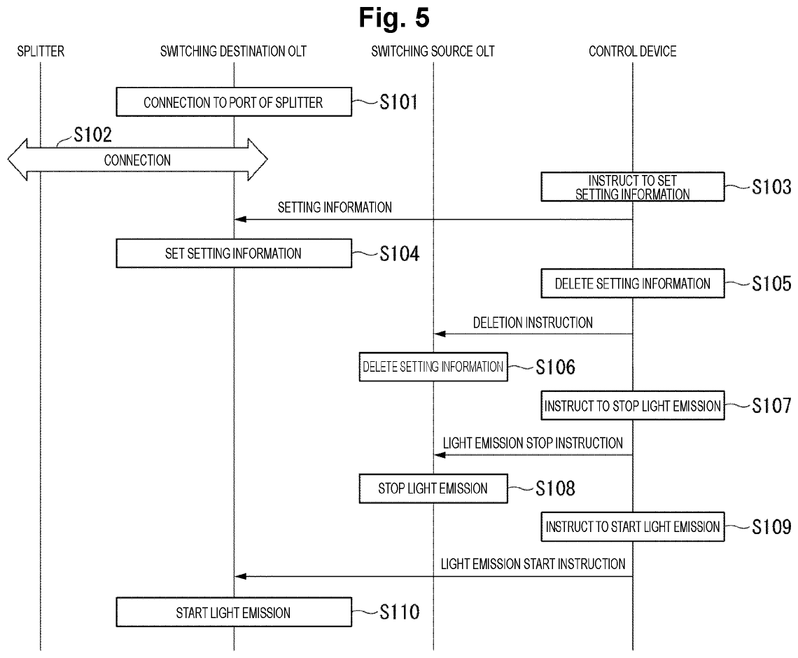

FIG. 5 is a sequence diagram illustrating a flow of processing performed by the optical communication system 100 in the embodiment.

An operator connects the switching destination OLT 20-2 to any of the standby-system ports of the M ports 31 of the splitter 30 in advance via the optical fiber (step S101). The term “in advance” herein means before executing switching of the switching source OLT 20-1. Thereby, the switching destination OLT 20-2 and the splitter 30 are connected (step S102).

At this point, in a case where an optical signal is transmitted from the ONU 40, the optical signal transmitted from the ONU 40 is branched by the splitter 30, and the branched optical signal is output from each port 31. In this case, since the switching destination OLT 20-2 is not yet operated, the switching destination OLT 20-2 does not receive the optical signal branched by the splitter 30.

The user sets the setting information for the switching destination OLT 20-2 by operating the control device 10. The OLT control unit 151 of the control device 10 acquires the setting information and the like of the switching destination OLT 20-2 from the storage unit 14 according to the user's operation. The OLT control unit 151 transmits the acquired setting information to the switching destination OLT 20-2 via the communication unit 11 (step S103).

The upper-layer communication unit 21 of the switching destination OLT 20-2 receives the setting information transmitted from the control device 10. The control unit 24 of the switching destination OLT 20-2 stores the setting information received by the upper-layer communication unit 21 in the storage unit 23, and sets a parameter or the like based on the setting information for the own device (step S104).

Next, the user instructs the switching source OLT 20-1 to delete the setting information by operating the control device 10. The OLT control unit 151 of the control device 10 transmits a deletion instruction of the setting information to the switching source OLT 20-1 via the communication unit 11 according to the user's operation (step S105).

The upper-layer communication unit 21 of the switching source OLT 20-1 receives the deletion instruction transmitted from the control device 10. The control unit 24 of the switching source OLT 20-1 deletes the setting information stored in the storage unit 23 based on the deletion instruction received by the upper-layer communication unit 21 (step S106).

Next, the user stops light emission of the switching source OLT 20-1 by operating the control device 10. The OLT control unit 151 of the control device 10 transmits a light emission stop instruction to the switching source OLT 20-1 via the communication unit 11 according to the user's operation (step S107).

The upper-layer communication unit 21 of the switching source OLT 20-1 receives the light emission stop instruction transmitted from the control device 10. The control unit 24 of the switching source OLT 20-1 stops light emission based on the light emission stop instruction received by the upper-layer communication unit 21 by controlling the lower-layer communication unit 22 (step S108). Thereby, transmission of the optical signal by the switching source OLT 20-1 is stopped.

After the light emission stop instruction of the switching source OLT 20-1, the user starts light emission of the switching destination OLT 20-2 by operating the control device 10. The OLT control unit 151 of the control device 10 transmits a light emission start instruction to the switching destination OLT 20-2 via the communication unit 11 according to the user's operation (step S109).

The upper-layer communication unit 21 of the switching destination OLT 20-2 receives the light emission start instruction transmitted from the control device 10. The control unit 24 of the switching destination OLT 20-2 starts light emission based on the light emission start instruction received by the upper-layer communication unit 21 by controlling the lower-layer communication unit 22 (step S110). Thereby, transmission of the optical signal by the switching destination OLT 20-2 is started.

According to the optical communication system 100 configured as described above, among the ports 31 of the splitter 30 to which the switching source OLT 20-1 is connected, the switching destination OLT 20-2 is connected to the standby-system port 31. The setting information which is set for the switching source OLT 20-1 is set for the switching destination OLT 20-2, and then communication by the switching destination OLT 20-2 is started. Thereby, the communication path is switched, and communication can be performed without being disconnected. Therefore, it is possible to switch the OLT 20 while suppressing occurrence of communication disconnection at the time of switching.

Further, in the optical communication system 100, when connection of the switching destination OLT 20-2 is completed, the user can perform switching by setting the setting information for the switching destination OLT 20-2. For this reason, there is no need to plug and unplug cables on a site on the day of switching the OLT 20. Therefore, a processing load of a local worker can be reduced.

Hereinafter, a modification example of the optical communication system 100 will be described.

### Modification Example 1

The splitter 30 may include a switch capable of switching a connection relationship of a transfer path between the port 31 and the port 32, and may be configured to switch a light emission destination. With such a configuration, the control device 10 sets, for the switching destination OLT 20-2, the setting information which is set for the switching source OLT 20-1, and then switches the connection with the port 32 from the port 31 (for example, the port 31-1) to which the switching source OLT 20-1 is connected to the port 31 (for example, the port 31-2) to which the switching destination OLT 20-2 is connected by controlling the switch. Thereby, it is possible to switch the OLT 20 without stopping light emission of the switching source OLT 20-1.

### Modification Example 2

It is also assumed that specifications of the switching source OLT 20-1 and the switching destination OLT 20-2 are different depending on version upgrade or the like. Therefore, in a case where specifications of the switching source OLT 20-1 and the switching destination OLT 20-2 are different, the control unit 24 of the switching destination OLT 20-2 may perform setting by replacing the setting information received by the upper-layer communication unit 21 with information suitable for the specification of the own device. Hereinafter, an operation related to replacing of the setting information in a case where specifications of the switching source OLT 20-1 and the switching destination OLT 20-2 are different will be described.

As an example, in a case where a buffer amount of the switching source OLT 20-1 is 4 Mbytes in total and a buffer amount of the switching destination OLT 20-2 is 2 Mbytes in total, the control unit 24 of the switching destination OLT 20-2 performs an operation of assigning the buffer amount to four queues at the same ratio. For example, in a case where 1 Mbyte is assigned to one queue in the switching source OLT 20-1, a ratio of each queue is 1:1:1:1. Therefore, the control unit 24 of the switching destination OLT 20-2 assigns 500 kByte to one queue such that the assignment ratio to each queue is the same as the assignment ratio in the switching source OLT 20-1. As described above, the control unit 24 of the switching destination OLT 20-2 sets setting information by performing replacing as described above instead of assigning 1 Mbyte to each queue in the same way as the switching source OLT 20-1.

With the configuration described above, even in a case where specifications of the switching source OLT 20-1 and the switching destination OLT 20-2 are different, the setting information can be set for the switching destination OLT 20-2.

Further, in a case where setting items of the switching source OLT 20-1 are not included in setting items of the switching destination OLT 20-2, the control unit 24 of the switching destination OLT 20-2 skips settings that are not included in the setting items of the switching destination OLT 20-2. Further, in a case where the switching destination OLT 20-2 has setting items that are not included in setting items of the switching source OLT 20-1, the control unit 24 of the switching destination OLT 20-2 performs setting using default values included in the switching destination OLT 20-2.

### Modification Example 3

In the above-described embodiment, the configuration in which the user switches the OLT by operating the control device 10 has been described. That is, in the above-described embodiment, the configuration in which the control device 10 executes an operation for the switching source OLT 20-1 (for example, step S105 and step S107 illustrated in FIG. 5) and an operation for the switching destination OLT 20-2 (for example, step S103 and step S109 illustrated in FIG. 5) in response to the user's instruction which is input to the control device 10 has been described. The operation by the control device 10 may be executed by other means regardless of the instruction input from the user.

For example, the operation by the control device 10 may be executed when the switching destination OLT 20-2 is connected to the splitter 30. In a case of such a configuration, the control device 10 stores a program that is started when it is detected that the switching destination OLT 20-2 is connected to the splitter 30 and executes processing illustrated in step S103, step S105, step S107, and step S109. The control device 10 operates in order of step S103, step S105, step S107, and step S109 based on the program. For example, processing of step S103 is executed when it is detected that the switching destination OLT 20-2 is connected to the splitter 30. Further, pieces of processing of step S105, step S107, and step S109 are executed when a response from the switching source OLT 20-1 or the switching destination OLT 20-2 is obtained. With such a configuration, it is possible to automatically set the setting information and switch the OLT without an operation by the user.

Some functions of the control device 10 and some functions of the OLT 20 in the above-described embodiment may be implemented by a computer. In that case, a program for realizing this function may be recorded in a computer-readable recording medium, and the program recorded in the recording medium may be read and executed by a computer system to realize this function. The “computer system” herein includes an OS and hardware such as a peripheral device. In addition, the “computer-readable recording medium” refers to a portable medium such as a flexible disk, a magneto-optical disk, a ROM, or a CD-ROM, or a storage device such as a hard disk built in a computer system. Further, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case. In addition, the program may be for realizing some of the functions described above, may be capable of realizing the functions described above in combination with a program already recorded in a computer system, or may be realized using a programmable logic device such as an FPGA.

Although the embodiment of the present invention has been described in detail with reference to the drawings, specific configurations are not limited to the embodiments, and include design and the like within the scope of the present invention without departing from the gist of the present invention.

### INDUSTRIAL APPLICABILITY

The present invention can be applied to a technique associated with switching of an optical communication device.

### Reference Signs List

10 Control device
11 Communication unit
12 Display unit
13 Operation unit
14 Storage unit
15 Control unit
20 OLT
20-1 Switching source OLT
20-2 Switching destination OLT
21 Upper-layer communication unit
22 Lower-layer communication unit
23 Storage unit
24 Control unit
30 Splitter
40 ONU
151 OLT control unit

1. A device switching method to be performed in an optical communication system, the device switching method comprising:
connecting a switching source optical subscriber line terminal station device to a first port of M first ports of an optical branching unit;
connecting a switching destination optical subscriber line terminal station device to any one of remaining first ports of the M first ports; and
starting communication by the switching destination optical subscriber line terminal station device after setting, for the switching destination optical subscriber line terminal station device, setting information which is set for the switching source optical subscriber line terminal station device,
wherein the optical communication system includes an upper-layer device, the switching source optical subscriber line terminal station device that is a device switching source, the switching destination optical subscriber line terminal station device that is a device switching destination, and the optical branching unit to which the switching source optical subscriber line terminal station device and the switching destination optical subscriber line terminal station device are connected, and
wherein the optical branching unit has a branching ratio of M:N (M and N are integers equal to or larger than 2) and has the M first ports and N second ports.

2. The device switching method according to claim 1, further comprising:
stopping, after setting the setting information, light emission of the switching source optical subscriber line terminal station device; and
starting light emission of the switching destination optical subscriber line terminal station device.

3. The device switching method according to claim 1, wherein
the optical branching unit includes a switch capable of switching a connection relationship of a transfer path between the M first ports and the N second ports, and the device switching method further comprises switching, after setting the setting information, connection with the N second ports from the first port to which the switching source optical subscriber line terminal station device is connected to the first port to which the switching destination optical subscriber line terminal station device is connected by controlling the switch.

4. The device switching method according to claim 1, further comprising: performing, in a case where specifications of the switching source optical subscriber line terminal station device and the switching destination optical subscriber line terminal station device are different, in the switching destination optical subscriber line terminal station device, setting by replacing the setting information with information suitable for the specification of the switching destination optical subscriber line terminal station device.

5. An optical communication system comprising: an upper-layer device; a switching source optical subscriber line terminal station device that is a device switching source; a switching destination optical subscriber line terminal station device that is a device switching destination; and an optical branching unit to which the switching source optical subscriber line terminal station device and the switching destination optical subscriber line terminal station device are connected, wherein
the optical branching unit has a branching ratio of M:N (M and N are integers equal to or larger than 2) and has M first ports and N second ports, the switching source optical subscriber line terminal station device is connected to one first port of the M first ports, the switching destination optical subscriber line terminal station device is connected to any one of the remaining first ports of the M first ports, and
the upper-layer device starts communication by the switching destination optical subscriber line terminal station device after setting, for the switching destination optical subscriber line terminal station device, setting information which is set for the switching source optical subscriber line terminal station device.
